(19) United States
(12) Patent Application Publication
(10) Pub. No.: US 2012/0138371 A1
(43) Pub. Date: Jun. 7, 2012

(54) TOUCH DEVICE

(76) Inventor: SHEE-YAU WU, TAINAN (TW)

(21) Appl. No.: 13/232,074

(22) Filed: Sep. 14, 2011

(30) Foreign Application Priority Data
Dec. 2, 2010 (TW) 099223410

(51) Int. Cl. G08C 21/00

(52) U.S. Cl. 178/18.01

(57) ABSTRACT

A touch device has multiple electromagnetic conductors and a detecting circuit. More than one of the multiple electromagnetic conductors are used as sensing points. Each of the sensing points receives a sensing voltage through electromagnetic coupling. The detecting circuit receives the sensing voltage and accordingly produces a sensing signal. A target device can be controlled based on the sensing signal. Since human body will absorb electromagnetic radiation from the surrounding environment, the touch device accomplishes the touch control based on electromagnetic coupling.

### BACKGROUND OF THE INVENTION

1. Field of the Invention

The invention relates to a touch device, and more particularly to a touch device that generates sensing signals based on electromagnetic coupling.

2. Description of Related Art

As a user-friendly operating interface, touch devices have been widely integrated into electronic products such as a guide-touring system in the amusement park, an intelligent mobile phone, a game console, an industrial work station, etc.

The touch device can detect the presence and location of a touch within a display area by sensing current/voltage variations. The conventional touch devices can be categorized into the resistive type, capacitive type, optical type, and acoustic type.

With reference to FIG. 11 showing the resistive type touch device, an ITO glass (B) and an ITO film (C) are attached on a display (A) and multiple spacers (D) are distributed between the ITO glass (B) and the ITO film (C). A 5-volt voltage is applied between the ITO glass (B) and the ITO film (C). When the ITO film (C) is touched or pressed by a user, the distorted ITO film (C) contacts the ITO glass (B) to cause voltage variation. The position of the touch can be determined by sensing the voltage variation. Such a voltage variation signal will be converted to a digital signal and input to the display to accomplish touch control. However, the resistive type touch devices only sense one single touch point and the detecting accuracy is relatively low. Further, the frequent touch actions will also cause scratches on the ITO film (C) and the ITO glass (B).

With reference to FIG. 12 showing the capacitive type touch device, two ITO films (F) are attached on a display (E) and a layer of glass (G) is provided between the two ITO films (F). A hard silica layer (H) is coated on the ITO film (F). A uniform electric field can be established over the surface of the layer of glass (G) by applying an additional voltage on the touch device. When a user presses the touch device, a small amount of current will be drained away via the human body from the device to ground. Based on the amount of the current, the position of a touch can be calculated and determined. In comparison to the resistive type, the capacitive type touch device is able to sense different positions of multiple touches simultaneously, and the scratches on the touch device can be mitigated.

Because the determination of the touch position is based on the current/voltage variation, either for the resistive type or the capacitive type touch device, an electrical current is necessary for the touch device.

### SUMMARY OF THE INVENTION

An objective of the invention is to provide a touch device that detects the presence and location of a touch based on the electromagnetic absorption and electromagnetic coupling of human body.

To accomplish the objective, the touch device comprises:

multiple electromagnetic conductors, wherein at least one of the multiple electromagnetic conductors is used as a sensing point, and the sensing point receives a sensing voltage by electromagnetic coupling;

a detecting circuit electrically connected to the multiple electromagnetic conductors to transmit the sensing voltages and produce a sensing signal based on the sensing voltages.

In the present invention, the sensing point is in a floating status. The floating status means there is no external power applied to the sensing point for generating an electric field. Because human body is able to absorb electromagnetic wave from the surroundings, the sensing point will generate the sensing voltage when it has been touched by a user through the electromagnetic coupling. The sensing voltage is then transmitted to the subsequent detecting circuit to produce the sensing signal. Therefore, a control circuit may control a target electronic device to perform a particular action based on the sensing signal, for example, to turn on or turn off a bulb.

Other objectives, advantages and novel features of the invention will become more apparent from the following detailed description when taken in conjunction with the accompanying drawings.

### BRIEF DESCRIPTION OF THE DRAWINGS

FIG. 1 is a first embodiment of a touch device in accordance with the present invention being used as a switch device;

FIG. 2 is an operational view of the first embodiment of the touch device in accordance with the present invention;

FIG. 3 is a circuit block diagram of the first embodiment of the touch device in accordance with the present invention;

FIG. 4 is a second embodiment of the touch device in accordance with the present invention;

FIG. 5 is a third embodiment of the touch device in accordance with the present invention;

FIG. 6 is a fourth embodiment of the touch device in accordance with the present invention;

FIG. 7 is a fifth embodiment of the touch device in accordance with the present invention;

FIG. 8 is an equivalent circuit diagram showing the relationships among a signal source, human impedance, electromagnetic conductors and an object to be touched;

FIG. 9 is a cross-sectional view of a first embodiment of an electromagnetic conductor in accordance with the present invention;

FIG. 10 is a cross-sectional view of a second embodiment of an electromagnetic conductor in accordance with the present invention;

FIG. 11 is a cross-sectional view of a conventional resistive type touch device; and

FIG. 12 is a cross-sectional view of a conventional capacitive type touch device.

### DETAILED DESCRIPTION OF THE PREFERRED EMBODIMENT

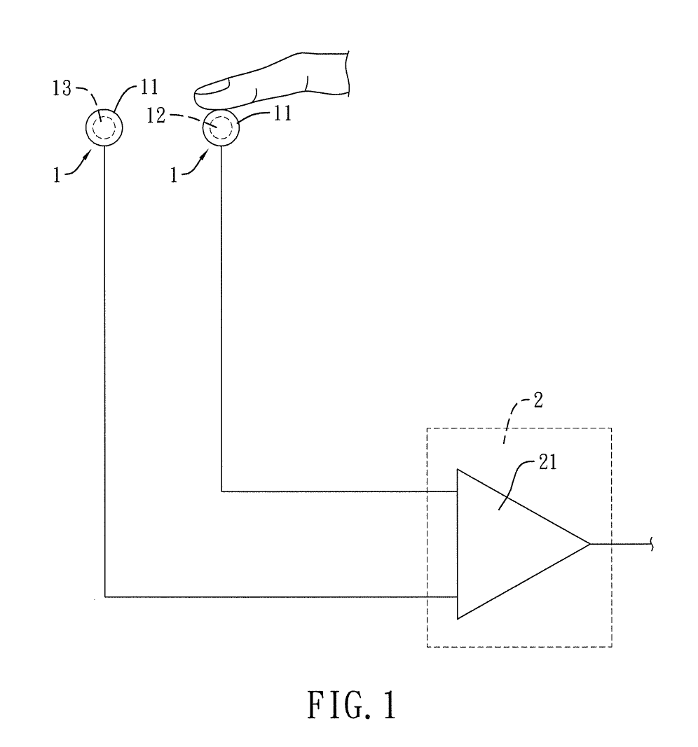

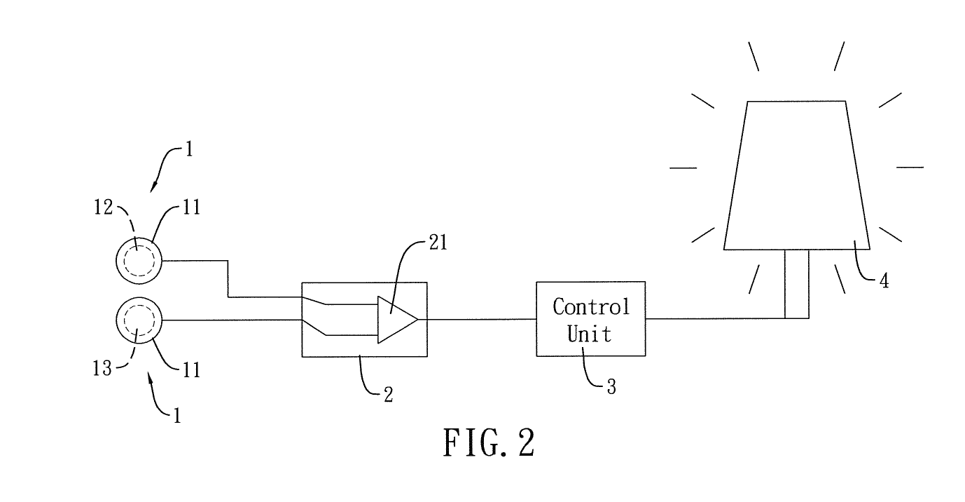

With reference to FIGS. 1 and 2, a first embodiment of a touch device of the present invention functions as a switch device and comprises two electromagnetic conductors (1) and at least one detecting circuit (2).

Each of the two electromagnetic conductors (1) is dot-shaped. An isolation coating (11) is optionally coated on each of the two electromagnetic conductors (1) in this embodiment. However, electromagnetic conductors (1) without isolation coating (11) are also feasible. One of the two electromagnetic conductors (1) is used as a sensing point (12) operable by a user, and the other electromagnetic conductor (1) is used as an optional reference point (13). The reference point (13) can be omitted and is able to provide reference information to enhance the accuracy of sensing result of the sensing point (12).

Each sensing point (12) cooperates with a separate detecting circuit (2). The detecting circuit (2) is electrically connected to the sensing point (12) and the optional reference point (13). The detecting circuit (2) comprises an amplifier (21). The amplifier (21) may be either a differential amplifier or an operational amplifier and is electrically connected to a control unit (3). The control unit (3) controls a target object (4), such as a lamp, an air conditioner, a door lock, or a faucet to be turned on or off.

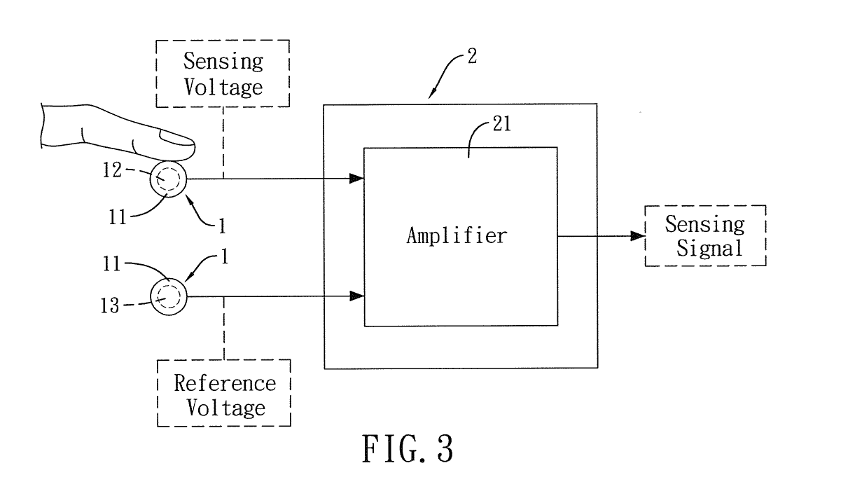

With reference to FIG. 3, because the human body will absorb the surrounding electromagnetic radiation from any electronic device, for example, a 60 Hz, 110-volt AC voltage power source, an inductance voltage will occur on the electromagnetic conductor (1) through the electromagnetic inductance when a person touches the electromagnetic conductor (1). An inductance voltage about 30 to 150 mV will occur if a person touches the isolation coating (11) around the two electromagnetic conductors (1) but not actually in contact with the electromagnetic conductors (1). In another situation, an inductance voltage about 10 volts will occur if the human body directly touches the electromagnetic conductors (1) without the isolation coating (11). Whenever the inductance voltage occurs, electronic circuits can sense the inductance voltage easily. The isolation coating (11) is coated on the electromagnetic conductor (1) as a protection. One of the electromagnetic conductors (1), i.e. the sensing point (12), is used to detect whether a person actually operates the touch device. The other electromagnetic conductor (1), i.e. the reference point (13), is used to sense electromagnetic radiation in the surrounding environment. Because the electromagnetic radiation exists in the surrounding space, the same inductance voltage can be detected on both the sensing point (12) and the reference point (13) even though a person does not actually contact the two electromagnetic conductors (1). The inductance voltage detected on the reference point (13) is defined as a reference voltage to compensate the effect of the surrounding electromagnetic radiation.

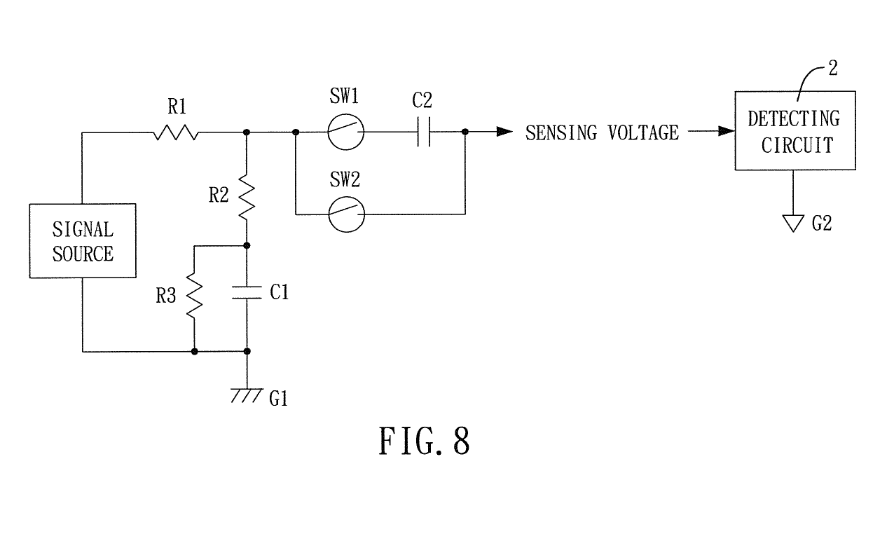

With reference to FIG. 8, the relationships among a signal source, human impedance, electromagnetic conductors and an object to be touched are shown by the equivalent circuit. The signal source means the surrounding electromagnetic wave in the environment. R1 is the impedance of a path for conducting the surrounding electromagnetic wave to human body. The human body impedance is expressed by R2, R3 and C1 for low frequency, wherein R2 and R3 represent an equivalent resistance of human body and C1 is an equivalent capacitance. The summation of R2 and R3 is approximately 100K ohms and C1 is approximately 200 pF. A first switch SW1 means a touch to the isolation coating (11) on the electromagnetic conductor (1). A second SW2 means a direct touch to the electromagnetic conductors (1) in the case that no isolation coating (11) is coated. C2 means the capacitance between the isolation coating (11) and the electromagnetic conductor (1) of the sensing point (12). It is noted that the human body and the touch device have different grounds G1, G2. With the different grounds G1, G2, the touch to the sensing point (12) can be easily sensed.

The sensing voltage and the reference voltage are input to and compared to each other by the amplifier (21) to generate a difference voltage. If the sensing voltage is very close to the reference voltage, the difference voltage is much lower than a threshold voltage. Therefore, the sensing point (12) is determined as being untouched and the amplifier (21) will output a first sensing signal. If the difference voltage is much higher than the threshold voltage, the sensing point (12) will be regarded as being touched, and the amplifier will output a second sensing signal. The control unit (3) receives the first sensing signal or the second sensing signal to turn on or turn off the target device (4) correspondingly.

Because of the high impedance of human body, the detecting circuit (2) should have a high input impedance capable of matching the human body impedance. Furthermore, the input of the amplifier (21) may be chosen from BJT transistors, MOS transistors, CMOS transistors or FET transistors. The output of the amplifier (21) may be decided by demand to have a proper threshold voltage for outputting a high state signal or a low state signal according to the application of the touch device.

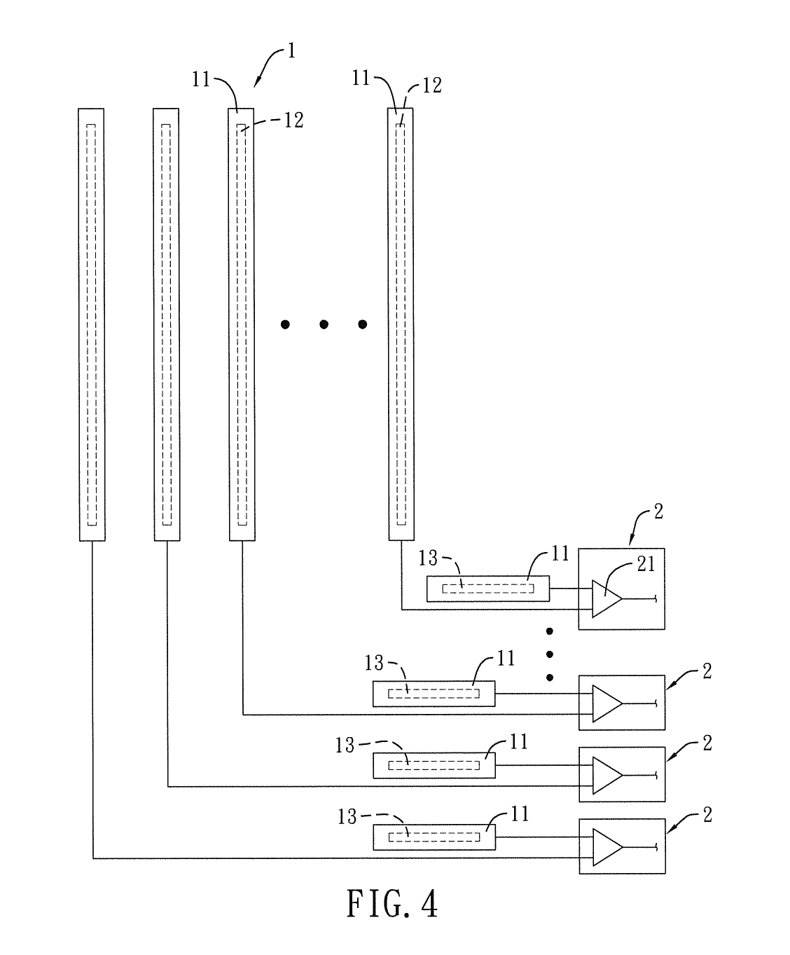

With reference to FIG. 4 showing the second embodiment of the touch device, each of the electromagnetic conductors (1) is line-shaped and one-dimensional. Multiple electromagnetic conductors (1) are distributed along an X-axis direction and separated from each other. The operations of the one-dimensional electromagnetic conductors (1) are the same as that described above. Each sensing point (12) is operated with a detecting circuit (2) and an optional reference point (13). The detecting circuits (2) are able to obtain the coordinate of any sensing point (12) that has been touched.

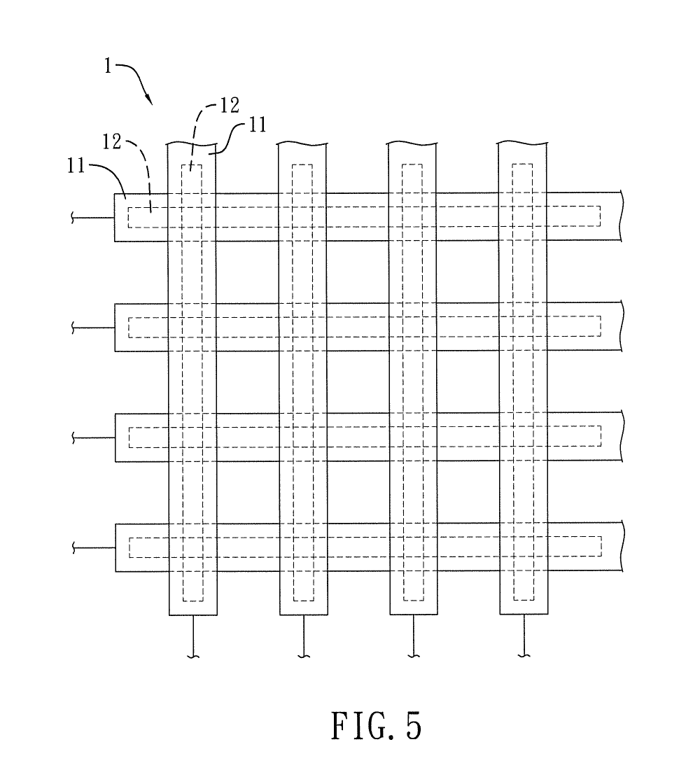

With reference to FIG. 5 showing the third embodiment of the touch device, each of the electromagnetic conductors (1) is line-shaped and one-dimensional. The multiple electromagnetic conductors (1) are arranged in a matrix configuration on a flat or curved plane, wherein a part of the electromagnetic conductors (1) are distributed along the X-axis direction and others are distributed along the Y-axis direction. Each of the electromagnetic conductors (1) is comprehensively coated with the isolation coating (11). In addition to the protection purpose, the isolation coating (11) electrically isolates the electromagnetic conductors (1) in X-axis direction from the electromagnetic conductors in Y-axis direction and avoids an electronic short circuit at the intersections of the electromagnetic conductors (1). Therefore, the second embodiment is able to accomplish a two-dimensional touch control.

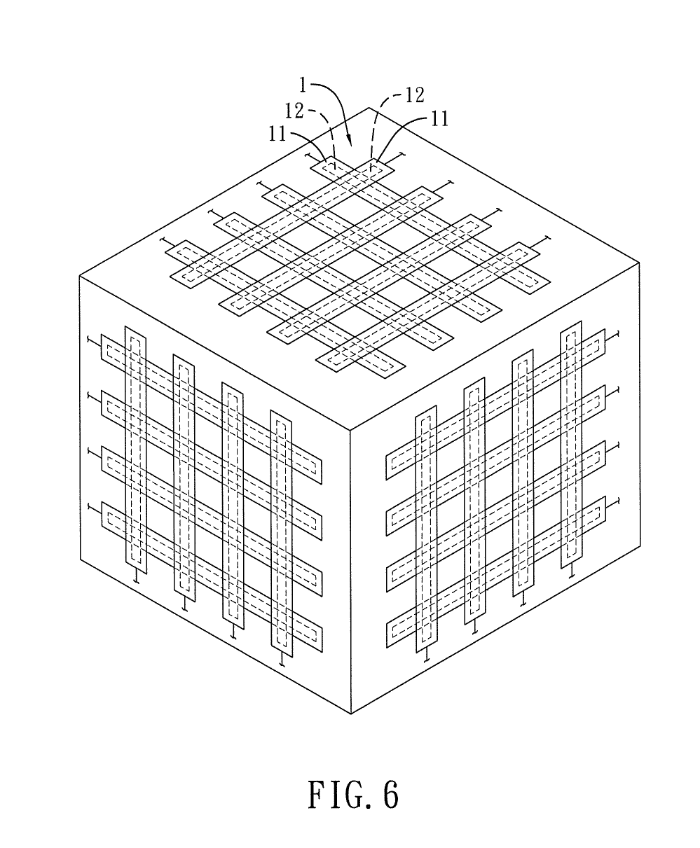

With reference to FIG. 6, the foregoing two-dimensional arrangement of the electromagnetic conductors (1) is applied to a three-dimensional object having at least one X-Y plane, one Y-Z plane and one X-Z plane. Only one of the planes, such as the X-Z plane, needs to be formed with the reference point (13). On each plane to be operated by the user, the line-shaped electromagnetic conductors (1) are arranged in a matrix configuration.

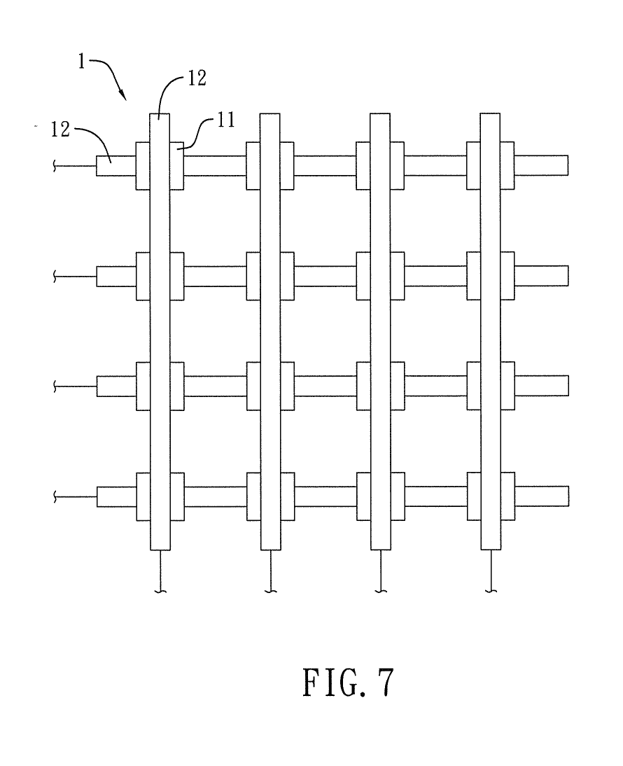

With reference to FIG. 7, the isolation coating (11) does not comprehensively cover the entire electromagnetic conductors (1) but is partially applied on the intersection regions of the electromagnetic conductors (1). The isolation coating (11) still prevents the electromagnetic conductors (1) in X-axis direction from electrically contacting the electromagnetic conductors (1) in Y-axis direction.

The foregoing described one-dimensional or two-dimensional electromagnetic conductors can be applied to different applications, for example, the electronic paper, the touch screen, touch game console, touch guide-touring system, etc. to accomplish the one-dimensional or two-dimensional touch control. Furthermore, the line-shaped electromagnetic conductors (1) may be integrated to the clothing, the purse, the toy, the hat, the shoes, the stationary or the like.

The sensing points (12) in each embodiment can individually receive a sensing voltage in response to a touch. Thus, the present invention is able to detect multiple touches at the same time. When the two-dimensional electromagnetic conductors (1) are applied to a touch display, the two-dimensional electromagnetic conductors (1) can be arranged in high density with small mesh and produce continuous sensing signals. Therefore, the touch display can be used as a handwriting device.

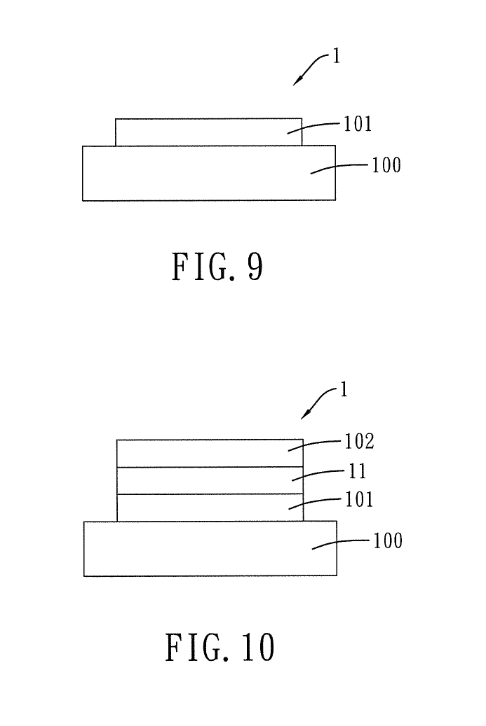

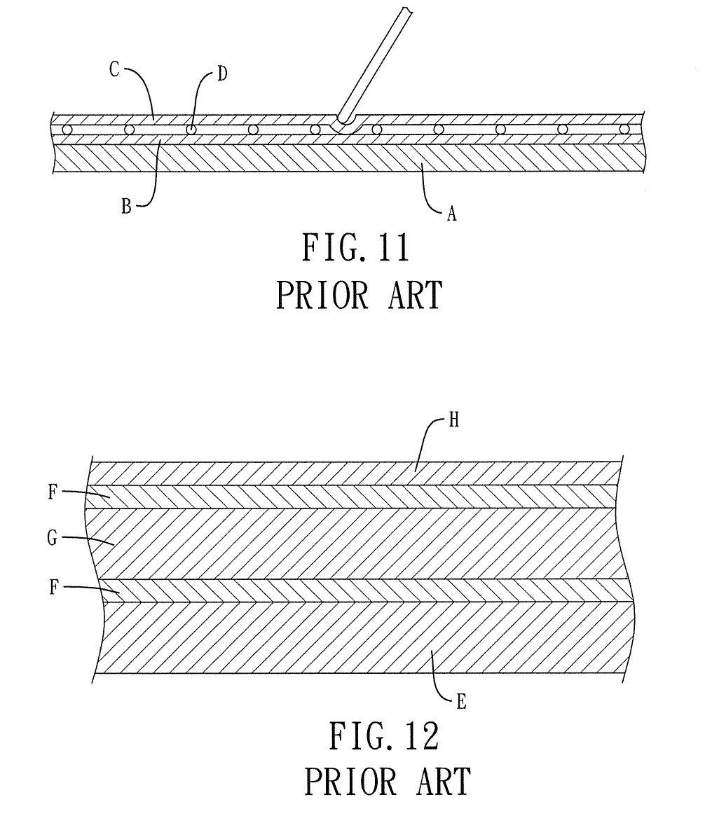

With reference to FIG. 9, the electromagnetic conductor (1) may comprise two layers, a base layer (100) and a first electromagnetic conductive layer (101) in the embodiments as shown in FIGS. 1 and 4. The base layer (100) can be made of glass or transparent film, such as PET film, EVA film or PVC film. The first electromagnetic conductive layer (101) may be chosen from pulp film, soap film, ink film, EPOXY film, photoresist film or adhesive glue film. The first electromagnetic conductive layer (101) is printed and then cured on the base layer (100). For example, the pulp, soap water or adhesive glue in fluid form may be printed on the base layer (100). After curing process, such as heating, a film of pulp, soap or adhesive glue remaining on the base layer (100) is used as the first electromagnetic conductive layer (101).

With reference to FIG. 10, for the embodiment as shown in FIGS. 5 and 7, the intersected electromagnetic conductors (1) may comprise a base layer (100), a first electromagnetic conductive layer (101), a second electromagnetic conductive layer (102) and an isolation layer (11). The base layer (100) can be made of glass or transparent film, such as PET film, EVA film or PVC film. The first electromagnetic conductive layer (101) and the second electromagnetic conductive layer (102) act as the conductors in different axis direction, i.e. the X-axis direction and Y-axis direction. Both the first electromagnetic conductive layer (101) and the second electromagnetic conductive layer (102) can be chosen from pulp film, soap film, ink film, EPOXY film, photoresist film or adhesive glue film. The isolation layer (11) is provided between the first electromagnetic conductive layer (101) and the second electromagnetic conductive layer (102) for isolating DC power.

What is claimed is:

1. A touch device comprising:
multiple electromagnetic conductors, wherein at least one of the multiple electromagnetic conductors is used as a sensing point, and the sensing point receives a sensing voltage by electromagnetic coupling induced by a user; and
a detecting circuit electrically connected to the sensing point to transmit the sensing voltages and produce a sensing signal based on the sensing voltages.

2. The touch device as claimed in claim 1, wherein one of the multiple electromagnetic conductors is used as a reference point that receives a reference voltage by electromagnetic coupling from surroundings; and
the detecting circuit transmits the sensing voltage and the reference voltage, and outputs the sensing signal based on a difference voltage between the sensing voltage and the reference voltage.

3. The touch device as claimed in claim 2, wherein the detecting circuit comprises an amplifier that compares the sensing voltage to the reference voltage to obtain the difference voltage.

4. The touch device as claimed in claim 3, wherein the amplifier is a differential amplifier or an operational amplifier.

5. The touch device as claimed in claim 1, wherein each of the multiple electromagnetic conductors is dot-shaped.

6. The touch device as claimed in claim 1, wherein each of the multiple electromagnetic conductors is line-shaped.

7. The touch device as claimed in claim 1, wherein the multiple electromagnetic conductors are arranged in a flat or curved plane.

8. The touch device as claimed in claim 5, wherein the multiple dot-shaped electromagnetic conductors are arranged in a one-dimensional line and separated from each other without overlapping.

9. The touch device as claimed in claim 6, wherein the multiple line-shaped electromagnetic conductors are arranged in a plane and separated from each other without intersecting.

10. The touch device as claimed in claim 9, wherein each of the line-shaped electromagnetic conductors is parallel to other line-shaped electromagnetic conductors.

11. The touch device as claimed in claim 6, wherein the multiple line-shaped electromagnetic conductors are arranged in a matrix configuration on a plane, part of the line-shaped electromagnetic conductors are distributed along an X-axis direction and others are distributed along a Y-axis direction to intersect the line-shaped electromagnetic conductors distributed along the X-axis direction; and
each of the line-shaped electromagnetic conductors is comprehensively coated with an isolation coating.

12. The touch device as claimed in claim 6, wherein the multiple line-shaped electromagnetic conductors are arranged in a matrix configuration on a plane, part of the line-shaped electromagnetic conductors are distributed along an X-axis direction and others are distributed along a Y-axis direction to intersect the line-shaped electromagnetic conductors distributed along the X-axis direction; and
an isolation coating is only formed at intersection regions of the line-shaped electromagnetic conductors to isolate the line-shaped electromagnetic conductors distributed along the X-axis direction from the line-shaped electromagnetic conductors distributed along the Y-axis direction.

13. The touch device as claimed in claim 6, wherein the multiple line-shaped electromagnetic conductors are arranged in a matrix configuration on planes of a three-dimensional object.

14. The touch device as claimed in claim 11, wherein the multiple line-shaped electromagnetic conductors are arranged on the plane of a three-dimensional object.

15. The touch device as claimed in claim 1, wherein each of the electromagnetic conductors has a base layer and a first electromagnetic layer formed on the base layer.

16. The touch device as claimed in claim 1, wherein each of the electromagnetic conductors has a base layer, a first electromagnetic layer formed on the base layer, an isolation layer formed on the first electromagnetic layer and a second electromagnetic layer formed on the isolation layer.
